(19) United States
(12) Patent Application Publication
(10) Pub. No.: US 2007/0186768 A1
(43) Pub. Date: Aug. 16, 2007

(54) RECOVERY OF WATER VAPOR USING A WATER VAPOR PERMEABLE MIXED ION CONDUCTING MEMBRANE

(75) Inventor: W. Grover Coors, Golden, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CoorsTek, Inc., Golden, CO (US)

(21) Appl. No.: 11/616,721

(22) Filed: Dec. 27, 2006

Related U.S. Application Data
(60) Provisional application No. 60/754,751, filed on Dec. 28, 2005.

(51) Int. Cl. B01D 53/22

(52) U.S. Cl. 95/52

(57) ABSTRACT

An apparatus for separating water vapor from a water-vapor containing gas mixture is described. The apparatus may include a mixed ion conducting membrane having at least a portion of one surface exposed to the water-vapor containing gas mixture and at least a portion of a second surface, that is opposite the first surface, that is exposed to a second gas mixture with a lower partial pressure of water vapor. The membrane may include at least one non-porous, gas-impermeable, solid material that can simultaneously conduct oxygen ions and protons. At least some of the water vapor from the water-vapor containing gas mixture is selectively transported through the membrane to the second gas mixture.

### CROSS-REFERENCES TO RELATED APPLICATIONS

This application claims the benefit of U.S. Provisional Patent Application No. 60/754,751 filed Dec. 28, 2005, entitled “RECOVERY OF STEAM FROM SOFC EXHAUST USING A PROTONIC CERAMIC MEMBRANE”, the entire contents of which are herein incorporated by reference for all purposes.

### BACKGROUND OF THE INVENTION

As the supply of easily transportable liquid fossil fuels gets more expensive to recover, industries and governments will increasingly have to rely on other materials for chemical feedstocks and energy. One alternative is the use of synthesis gas (i.e., a mixture of carbon monoxide and molecular hydrogen) to make chemical feedstocks and supply energy carriers. The components of synthesis gas, brought together at the proper concentration ratios, temperatures, and pressures, can produce a variety of chemical feedstocks based on the Fischer-Tropsh synthesis including methanol, acetic acid, ethylene, paraffins, aromatics, olefins, ethylene glycol, and liquid fuels such as ethanol, propanol, butenol, dimethyl ether, kerosene, diesel and gasoline, among other hydrocarbon products. Synthesis gas may also be combusted directly for heating, or in a heat engine for producing electric or mechanical power, or in a solid oxide fuel cell for producing electric power. The molecular hydrogen component of synthesis gas may be used as a fuel for transportation, heating, and electricity generation that combusts in oxygen with only environmentally benign water vapor (i.e., steam) as the exhaust gas. Furthermore, synthesis gas production may involve various combinations of chemical feedstock and power co-production or co-generation.

Synthesis gas can be generated from natural gas (e.g., CH₄) coal, and biomass, materials that are widely available. Synthesis gas is produced from methane by steam reforming. The process involves the mixing of natural gas (e.g., methane) and water vapor at about 800° C. under pressures of about 1 atm, and generally in the presence of suitable catalysts, such as nickel. When a fuel such as methane is steam reformed, the thermochemical energy content of the resulting hydrogen and carbon monoxide is actually greater than that of the parent fuel. This is because reforming is endothermic, and some of the external heat supplied to a steam reforming reactor is channeled into converting additional hydrocarbons into hydrogen and carbon monoxide. Steam reforming can be described chemically by the formula:
CH₄+H₂O→CO+3H₂ (1a)
Quantifying the additional energy of the reformation products, the enthalpy of combustion of CH₄ is about −800 kJ/mol, while the enthalpy of combustion of one mole of CO plus 3 moles of H₂ is −1025 kJ/mol at 1000° K.

Water vapor is also used to generate synthesis gas from coal in the water-gas reaction. The water-gas reaction involves exposing the coal C(s) to high temperature water vapor (e.g., 800° C.) to produce the synthesis gas:
C(s)+H₂O→CO+H₂ (1b)

When energy generation is the principal focus, the carbon monoxide component can be further oxidized to carbon dioxide (CO₂) to generate additional energy. Because carbon dioxide is a known greenhouse gas, its sequestration rather than emission into the atmosphere may be highly desirable.

For producing synthesis gas from either natural gas, coal or other hydrocarbon feedstocks, such as biomass, a successful process must supply a regulated amount of water vapor at high temperature. High temperature water vapor is typically a reaction product from both feedstock generation and energy supply operations (e.g., the combustion of H₂ produces water vapor). Thus, the efficiencies of synthesis gas production processes would be increased significantly if the water vapor could be easily separated from other reaction products at elevated temperatures, and recycled back into making more synthesis gas. A recycling process that separates water vapor from carbon dioxide would also have application in apparatuses and processes for carbon sequestration. For many hydrocarbon combustion processes, the reaction products are energy, water vapor, and carbon dioxide. An apparatus that could separate some of the combustion energy and water vapor from the carbon dioxide could provide useful work in addition to concentrating carbon dioxide for sequestration.

Unfortunately, at the temperatures involved, conventional water separation and purification equipment involving organic polymer membranes are unsuitable. Thus, there is a need for new water vapor separation/purification apparatuses, systems and processes that are compatible with the processes of generating synthesis gas.

### BRIEF SUMMARY OF THE INVENTION

Embodiments of the invention include apparatuses for separating water vapor from a water-vapor containing gas mixture. The apparatuses may include a mixed ion conducting membrane having at least a portion of one surface exposed to the water-vapor containing gas mixture and at least a portion of a second surface, that is opposite the first surface, that is exposed to a second gas mixture with a lower partial pressure of water vapor. The membrane may include at least one non-porous, gas-impermeable, solid material that can simultaneously conduct oxygen ions and protons. At least some of the water vapor from the water-vapor containing gas mixture is selectively transported through the membrane to the second gas mixture.

Embodiments of the invention also include methods of separating water vapor from a water-vapor containing gas mixture. The methods may include the step of providing a mixed ion conducting membrane that has at least one non-porous, gas-impermeable, solid material that can simultaneously conduct oxygen ions and protons. The method may also include exposing a first surface of the membrane to the water-vapor containing gas mixture and a second, opposite surface of the membrane to a second gas mixture with a lower partial pressure of water vapor. At least some of the water vapor from the water-vapor containing gas mixture is selectively transported through the membrane to the second gas mixture.

Embodiments of the invention still further include methods of concentrating carbon dioxide in a carbon dioxide and water vapor containing gas mixture. The methods may include the step of providing a mixed ion conducting membrane having at least one non-porous, gas-impermeable, solid material that can simultaneously conduct oxygen ions and protons and is impermeable to carbon dioxide. The methods may also include the steps of exposing a first surface of the membrane to the carbon dioxide and water-vapor containing gas mixture and a second, opposite surface of the membrane to a second gas mixture having a lower partial pressure of water vapor, and concentrating the carbon dioxide in the carbon dioxide and water vapor containing gas mixture by selectively transporting at least some of the water vapor to the second gas mixture.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A shows a simplified schematic of two gases separated by a steam permeable membrane according to embodiments of the invention;

FIGS. 1B and C show a simplified schematic of a steam permeable membranes on a porous support substrates according to embodiments of the invention;

FIG. 2 shows a tubular steam permeable membrane that may be used in a water-vapor transport device according to embodiments of the invention;

FIG. 3 shows a coiled steam permeable membrane that may be used in a water-vapor transport according to embodiments of the invention;

FIG. 4 shows a cross section of a steam permeable membrane according to embodiments of the invention;

FIG. 5 shows a catalytic reactor with conduits containing mixed ion conducting steam permeable membranes according to embodiments of the invention;

FIG. 6 is a flowchart illustrating methods of transferring water vapor with a mixed ion conducting membrane according to embodiments of the invention;

FIG. 7 is a flowchart illustrating methods of carbon sequestration with a mixed ion conducting membrane according to embodiments of the invention;

FIG. 8 is a plot of equilibrium mole fraction of various species versus steam to carbon ratio for methane at 800° C.;

FIG. 9 is a plot of the degree of hydration versus temperature at constant pH₂O for BCY10 and BZY10; and

FIG. 10 is a plot of steam permeation flux predicted for a 500 μm ceramic membrane with pH₂O(moist)=0.5 atm, and pH₂O(dry)=0.01 atm.

### DETAILED DESCRIPTION OF THE INVENTION

The invention relates to apparatuses, systems, and methods for separating water vapor (a.k.a. “steam”) from a water-vapor containing gas mixture with a mixed ion conducting (MIC) membrane. The membrane includes a solid, non-porous, and gas-impermeable material that can simultaneously conduct oxygen ions and protons. Oxygen ions (O²⁻) donated from water molecules in the water-vapor containing gas mixture fill exposed oxygen vacancies on a surface of the membrane. At the same time, the hydrogen ions (or equivalently, protons) from the water molecule fill sites near the oxygen ions in the membrane lattice. Because the oxygen vacancies and protons have the same type of charge (positive) they can move in opposite directions across the interior bulk of the membrane to opposite surfaces (i.e., ambipolar diffusion).

When the positive hydrogen ions arrive at a surface opposite the one exposed to the water-vapor containing gas mixture, they can recombine with an oxygen ion to make a neutral water molecule. This water molecule may then be released at the opposing surface to join a second gas mixture that has a lower concentration of water vapor. The net result is that the water molecule migrates across the membrane from one gas mixture to another. However, because the membrane is non-porous and “gas-impermeable” other gases such as nitrogen, methane, carbon monoxide, carbon dioxide, cannot also migrate across the MIC membrane in substantial amounts. This makes the membrane highly-selective for separating water vapor from other components of the gas mixture.

In addition, the membrane has other characteristics of a ceramic that make it useful for water vapor separation (and purification) in high-temperature synthesis gas production processes. Ceramic steam permeable membranes, unlike plastics and other organic polymers, have melting points that are above the temperatures needed for synthesis gas production from the reaction of water vapor with natural gas or coal. This allows the in-situ recycling of high temperature water vapor during processes of making and using synthesis gas for energy and/or chemical feedstocks.

Exemplary Water Vapor Transport Membranes

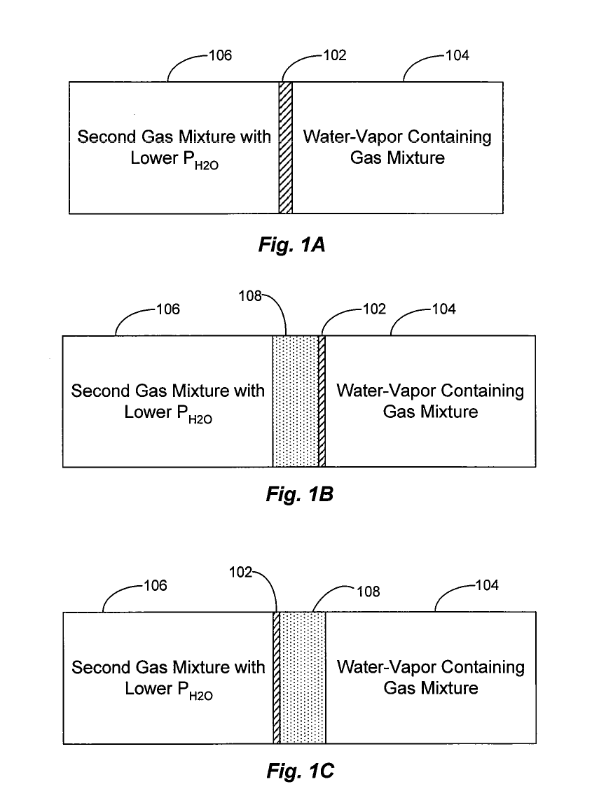

FIG. 1A shows a simplified schematic of two gases separated by a water vapor (a.k.a. steam) permeable membrane 102 according to embodiments of the invention. The membrane 102 may be a mixed ion conducting membrane that is solid and non-porous. It may also be impermeable to the passive diffusion of gases, but still allow the active transport of water vapor between a water-vapor containing gas mixture 104 and a second gas mixture with a lower partial pressure of water (i.e., P_{H2O}).

The membrane 102 may be made from one or more mixed ion conducting materials, such as a perovskite ceramic. Suitable perovskite ceramics may include those that have a general formula ABO₃, where A is selected from the group consisting of calcium, strontium, barium, lanthanum, a lanthanide series metal, an actinide series metal, and a mixture thereof, and B is selected from a group consisting of zirconium, cerium, yttrium, titanium, transition metals and mixtures thereof. Additional examples of mixed ion conducting materials that may be used in embodiments of the invention include BaZr₁₋ₓYₓO₃₋₆, where x is less than 0.5, and δ is 0 to x/2. Additional details of these and other mixed ion conducing materials are described in U.S. Pat. No. 7,045,231 by Coors, titled “DIRECT HYDROCARBON REFORMING IN PROTONIC CERAMIC FUEL CELLS BY ELECTROLYTE STEAM PERMEATION” the entire contents of which are herein incorporated by reference for all purposes.

Because the membrane is a mixed ion-conducting membrane that only requires the migration of ions (e.g., protons and positively charged oxygen vacancies) the membrane does not need an external electric current to transport the water vapor. In fact, the electrical conductivity of the membrane can be relatively low compared with the ion conductivity, which can account for about 90% to about 99% of the total conductivity of the membrane.

The water-vapor containing gas mixture 104 may include a variety of additional gases in addition to the water vapor. For example, the gas mixture 104 may also include carbon monoxide, carbon dioxide, molecular nitrogen, nitrogen oxides, sulfur oxides, molecular oxygen, volatile organic compounds (e.g., methane, ethane, propane, aromatics, etc.), ammonia, and volatile organic oxide compounds (e.g., methanol, ethanol, etc.) and inert gases, and mixtures thereof, among other kinds of gases. In a specific example, the gas mixture 104 may include hydrocarbon combustion products that are primarily carbon dioxide and water vapor. The second gas mixture 106 may include some or all of the same gases listed above for the water-vapor containing gas mixture 104. It may include one or more of a kind of gas not listed above. The second gas mixture 106 may include water vapor, but at a concentration level (P_{H2O}) that is less than the water-vapor concentration level for the first gas mixture 104.

Referring now to FIG. 1B, a simplified schematic of a water vapor permeable membrane on a porous support substrate 108 according to embodiments of the invention is shown. The porous support substrate 108 may be permeable to the second gas mixture 106 in contact with the substrate, and also permeable to the water vapor released from the surface of membrane 102 that faces the substrate. The support substrate 108 helps support membrane 102, which may be relatively thin (e.g., having a thickness of about 0.1 mm or less). In some embodiments, the membrane 102 may be formed as a coating on a surface of the support substrate. Also, in some embodiments, the porous support substrate 108 may be permeable to the first gas mixture in contact with the membrane 102.

The support substrate 108 may be made from one or more inert materials that permit the diffusion of gases at the temperatures and pressures used in the water vapor transport operations of the membrane 102. The support may be made from an ionically conducting material, an electron-conducting material, a mixed oxide conducting material, and/or the same material as the mixed ion conducting membrane 102. The substrate 108 may be made from a material having thermal expansion properties that are compatible with the membrane 102, and other material layers in contact with the substrate. The substrate 108 may also be made from materials that do not adversely chemically react with the other layers or the gas mixtures under process operating conditions. Some specific examples materials that may be used as support substrate 108 include without limitation alumina (Al₂O₃), silica (SiO₂), ceria (CeO₂), zirconia (ZrO₂), titania (TiO₂), magnesium oxide (MgO), and mixtures thereof. The substrate may also be doped with one or more alkaline earth metals, lanthanum, lanthanide series metals, and mixtures thereof. The support substrate may also contain catalyst materials for enhancing the kinetics of chemical reactions.

It should also be appreciated that the positions of the membrane 102 and support substrate 108 may be reversed with respect to the gas mixtures. FIG. 1C shows the membrane 102 in direct contact with the second gas mixture 106 while the support substrate 108 is in direct contact with the water-vapor containing gas mixture 104. The reversal of the membrane 102 and support substrate 108 relative to the gas mixtures as shown in FIG. 1C may also be accomplished by reversing the positions of the gas mixtures in FIG. 1B. In this embodiment (not shown) the positions of the water-vapor containing gas mixture 104 and the second gas mixture 106 are switched so that membrane 102 directly contacts the second gas mixture and the support substrate 108 makes directly contacts the water-vapor containing gas mixture. In both situations, the more concentrated water vapor first migrates through the porous support substrate 108 before permeating through the mixed ion conducting membrane 102.

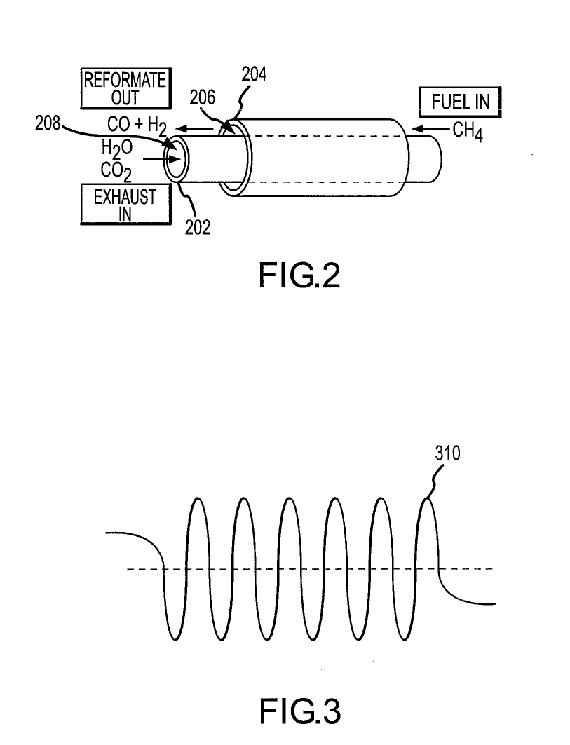

FIG. 2A shows a tubular steam permeable membrane that may be used in a water-vapor transport device according to embodiments of the invention. In the embodiment shown, an inner conduit tube 202 that includes a mixed ion conducting membrane is surrounded by a second outer conduit tube 204 that defines a first region 206 between the inner conduit and outer conduit. A water-vapor containing gas mixture that includes the exhaust from a hydrocarbon combustion process flows through a second region 208 inside the inner conduit 202. A second gas mixture that includes hydrocarbon fuel gases (e.g., CH₄) flow through the region 206 between the outer and inner conduits. At operational temperatures, a portion of the water vapor in region 208 inside the inner conduit reaches a surface of the mixed ion conducting membrane in conduit tube 202. At the surface, the water dissociates and contributes a oxygen ion (O²⁻) to a oxygen vacancy at the membrane surface, and a pair of hydrogen ions (i.e., protons) (2H⁺) enter interstitial sites at the membrane surface.

Through a process of ambipolar diffusion, the oxygen vacancies and protons migrate in opposite directions through the membrane in tube 202. Once at the membrane surface opposite the one facing region 208 inside the inner conduit, the protons and oxygen ions can recombine back into water molecules and escape into the second gas mixture in region 206 between the inner and outer conduits. Thus, the water vapor from the gas mixture inside conduit tube 202 is selectively transported across the conduit to the second gas mixture. It should be noted that the water molecules do not migrate intact through the inner conduit 202, but instead dissociate and migrate as ions across the mixed ion conducting membrane that makes up at least part of the conduit. Thus, while the oxygen and hydrogen units move from the second region 208 to the first region 206, they may be recombined into different water molecules when they are released into the first region 206. This should cause no differences in the physical and chemical properties of the water vapor that has migrated through the membrane.

It should also be appreciated that the migration of the water vapor from the second inner region 208 to the first region 206 between the inner and outer conduits can be reversed. For example, if the concentration (P_{H2O}) of water vapor in first region 206 increases beyond the concentration of water vapor in the second inner region 208, the water molecules will migrate from the first region 206 to the second region 208. In another example, the compositions of the gas mixtures in the two regions 206 and 208 may be switched so the water containing gas mixture is in the first region 206 between the inner and outer conduits and the second gas mixture occupies the second region 208 in the inner conduit. In this case also, the water vapor will migrate from the first region 206 to the second region 208 where the concentration of water vapor is lower.

Additional shapes for the conduit beyond a circular cross-sectional profile are also contemplated. For example, the inner and outer conduits 202 and 204 may have an elliptical, triangular, square, rectangular, trapezoidal, hexagonal, or octagonal cross-sectional profile, among other shapes.

Just as the water vapor moves in accordance with a concentration gradient from regions of high concentration to low concentration, heat can also migrate across the mixed ion conducting membrane from regions of higher temperature to lower temperature. Thus, the mixed ion conducting membrane may act as both a water vapor and heat transport material. The combination makes the membrane well suited for use in high temperature chemical reaction processes (e.g., Fischer-Tropsch reactions) where high temperature water may act as both a reactant and product at different steps of the reaction. The membrane is also useful for recycling high temperature water vapor that hasn't been consumed in the reaction process. The membrane is still further useful for taking high temperature water vapor generated in an organic combustion process for heat and/or energy and providing it directly to a chemical synthesis that requires high temperature water vapor (e.g., a synthesis gas production process such as steam reforming and the water-gas reaction of coal).

For scaled processes that circulate large volumes of gas mixtures, it may sometimes be advantageous to design conduits that increase the surface area to volume ratio between the gases and the surfaces of the mixed ion conducting membrane. FIG. 3 shows an embodiment of a tubular steam permeable membrane that is coiled to increase the surface area of membrane in the volume of space around the coil. The coil 310 may be a tubular conduit that holds a gas mixture at one water vapor concentration level that is different than the water vapor concentration in the gas mixture outside the conduit. The outside gas mixture may be enclosed by an outer tube (not shown) or some other shaped container that prevents the outside mixture from escaping. It should be appreciated that the tubular conduit may be shaped or wound in additional configurations (e.g., spherical, intertwined helices, etc.).

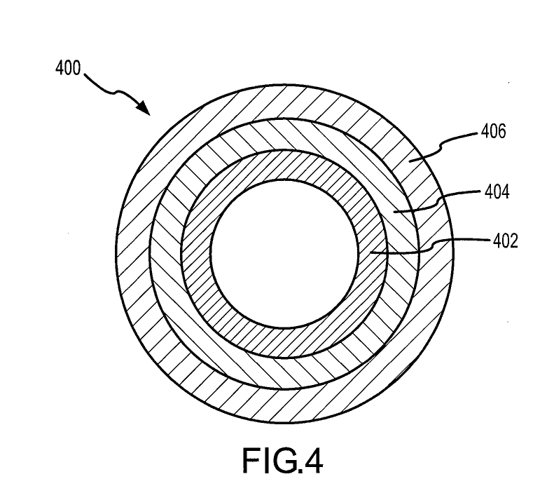

Embodiments of mixed ion conducting membranes may be incorporated into multilayer sheets or conduits that facilitate chemical reactions to produce products such a synthesis gas. FIG. 4, for example shows a cross section of a reaction conduit 400 that includes a steam permeable membrane according to embodiments of the invention. The multilayer reaction conduit 400 includes a mixed ion conducting membrane 402, a porous support substrate 404, and catalyst layer 406 combined to form the conduit. As noted above, the mixed ion conducting membrane may be used for the selective transport of water vapor from one gas mixture to another, and the porous support substrate 404 may be used to support a thin, fragile conducting membrane 402.

The catalyst layer 406 may include a material that catalyzes a reaction between the transported water molecules and other reactants exposed to the catalyst material. For example, the catalyst layer may include a catalyst material such as nickel or other catalytically active material that catalyzes the reaction of methane and water vapor in a steam reforming reaction to make molecular hydrogen and carbon monoxide.

In the embodiment shown in FIG. 4, the support substrate 404 is positioned between the mixed ion conducting membrane 402 and the catalyst layer 406. Additional embodiments (not shown) vary the order of the three layers so that, for example, the support substrate 404 or the conducting membrane 402 are the outermost concentric layer. Embodiments also include combining the support substrate 404 and the catalyst layer 406 into a single layer that provides support for the conducing membrane 402 and catalyzes a reaction between the transported water molecules with other reactants exposed to the combined layer.

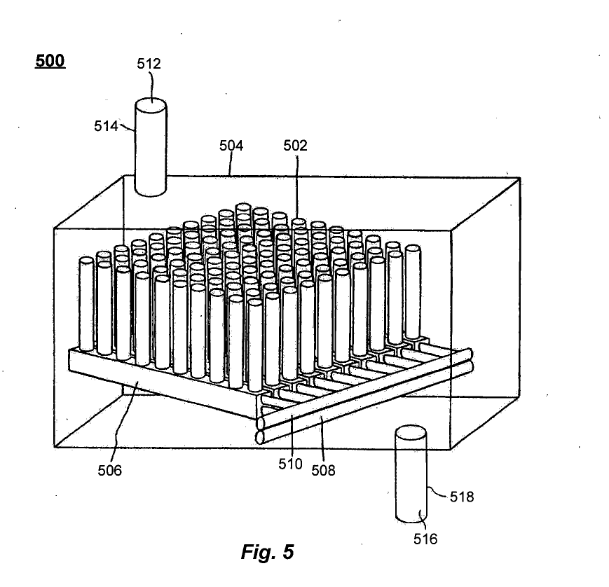

FIG. 5 shows a catalytic reactor 500 with conduits containing mixed ion conducting steam permeable membranes according to embodiments of the invention. The reactor 500 may include an array of tubes 502 that each contain a mixed ion conducting membrane for separating water vapor from a water vapor containing gas. The tubes 502 are closed-end to prevent the water vapor containing supply gas from mixing freely with the separated water vapor and other reactant gases inside the reactor chamber 504. The array of tubes 502 are in fluid communication with a manifold 506 that supplies the water vapor containing supply gas to the tubes and removes water-vapor depleted supply gas from the tubes. A gas inlet conduit 508 delivers the water vapor containing supply gas to the tubes 502 via manifold 506. After the supply gas has passed through the tubes 502 and a portion of the water vapor removed from the gas, the water-vapor depleted supply gas is removed through the manifold 506 and outlet conduit 510.

The water vapor that was transported through the mixed ion conducting membrane in tubes 502 enters the reactor chamber 504 from the tube surfaces exposed to the chamber. A reactant gas 512 is supplied to the chamber 504 via reactant gas supply tube 514, and the gas 512 mixes and reacts with the water vapor permeating through the tubes 502. The products 516 of the reaction of reactant gas 512 and the water vapor are removed from the reactor chamber 504 via reaction product outlet port 518.

Exemplary Methods of Transferring Heat and Steam

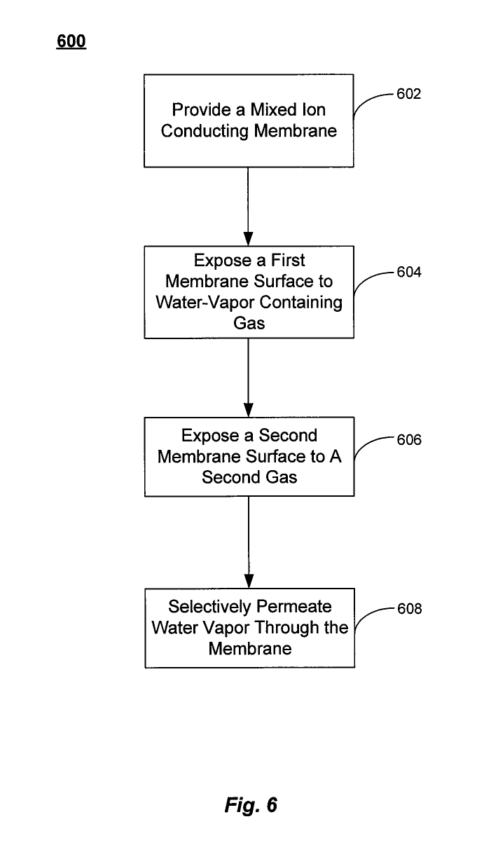

Referring now to FIG. 6, a flowchart illustrating embodiments of methods of transferring water vapor with a mixed ion conducting membrane according to the invention is shown. Method 600 includes the step of providing a mixed ion conducting membrane 602 that can selectively separate water vapor from other components of a water-vapor containing gas mixture. As noted above, the mixed ion conducting membrane may be a solid and non-porous membrane that is impermeable to the passive diffusion of gases, but allows the active transport of water vapor by means of an ambipolar diffusion process.

A first surface of the membrane may exposed to a first, water-vapor containing gas mixture 604, while a second surface that is on an opposite side of the membrane as the first surface may be exposed to a second gas mixture 606 that has a lower concentration of water vapor (P_{H2O}) than the first gas mixture. The two different gas mixtures set up a concentration gradient for the water vapor, which selectively permeates across the membrane 608 from an area of higher concentration (i.e., the first gas mixture) to lower concentration (i.e., the second gas mixture).

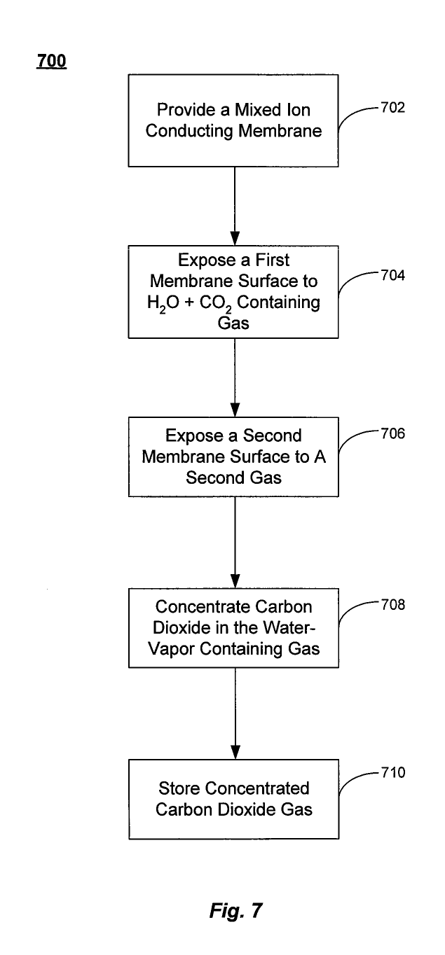

While the mixed ion conducting membranes may be permeable only to water vapor, water vapor permeation can be used to concentrate other gases in the gas mixture. For example, FIG. 7 is a flowchart illustrating some steps in a method 700 of carbon sequestration with a mixed ion conducting membrane according to embodiments of the invention. The method 700 includes the step of providing the mixed ion conducting membrane 702 and exposing a first surface of the membrane to a first water-vapor and carbon dioxide containing gas mixture 704. A second surface of the membrane is exposed to a second gas 706 with a lower concentration of water vapor that creates a water-vapor concentration gradient. The water vapor is actively transported across the membrane from the water vapor and carbon dioxide containing gas mixture to the second gas, while the carbon dioxide stays part of the first gas.

As the water vapor is depleted from the water-vapor and carbon dioxide containing gas mixture, the level of CO₂ in the mixture becomes more concentrated 708. For starting gas mixtures that consist mostly of carbon dioxide and water vapor (e.g., exhaust gas from hydrocarbon combustion) the final gas mixture after the water vapor permeation will consists mostly of carbon dioxide. The concentrated carbon dioxide gas mixture may then be stored 710 instead of being released into the atmosphere. Thus, for hydrocarbon combustion processes that produce large amounts of carbon dioxide and water vapor, the mixed ion conduction membranes provide a way to separate and sequester the concentrated carbon dioxide.

Mixed Ion Conducting Membranes in Fuel Cells

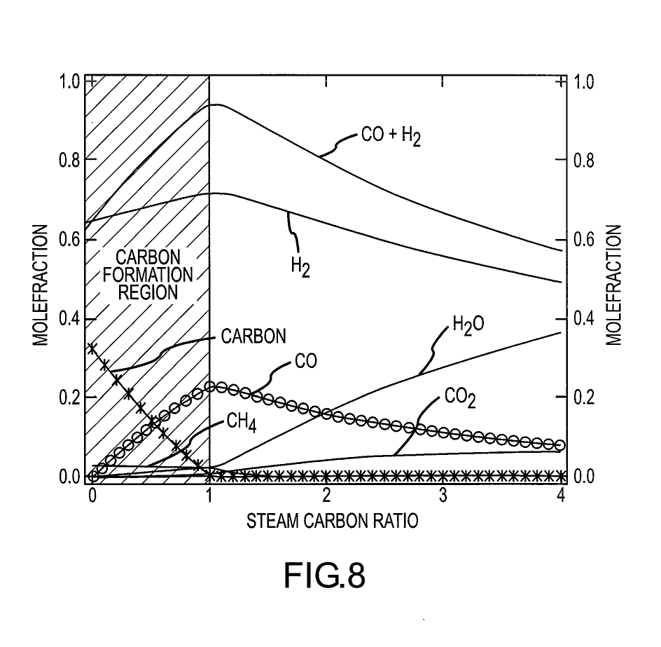

FIG. 8 shows the equilibrium mole fractions of various majority species versus steam to carbon ratio (S/C) for methane at 800° C. For S/C less than 1, methane pyrolyzes and coke formation is expected, particularly in the presence of a catalyst. At S/C just above unity, coke formation is suppressed and the yield of the electroactive species, H₂ and CO, is maximized. At still higher S/C, the mole fraction of combustion products, CO₂ and H₂O, steadily increases while the electroactive species decrease. The result is a fuel mixture with diminished capacity to produce electrical power per unit of methane fuel. It may be observed that methane is not very stable at 800° C. at equilibrium at any S/C ratio. For maximum fuel cell efficiency, the ideal S/C ratio is slightly above 1; that is, one mole of H₂O for each mole of methane entering the fuel cell. Of course, this analysis, which only considers Gibbs free energy minimization, says nothing about the rate kinetics of the various reactions, and suitable catalysts must be used to ensure that the desired reactions proceed to completion. In practice, it may not be necessary to achieve chemical equilibrium or to reform all of the hydrocarbon fuel entering a SOFC. It may only be necessary to maintain the S/C ratio of the gas entering the anode channel of the stack so that coke does not form on the Ni/YSZ anode support. Additional water vapor is produced at the anode during fuel cell operation under load to reform any remaining hydrocarbon fuel.

The precise delivery of steam into the inlet fuel channel using conventional approaches is extremely challenging. The difficulty has to do with making the steam, injecting it into the fuel at high temperature and in the correct ratio, and controlling the water/steam cycle. A 5 kW SOFC operating at 90% fuel utilization consumes about 25 moles of natural gas per hour. The amount of (deionized) water required to reform this quantity of methane is about half a kilogram (half a liter) per hour, or almost 1200 gallons per year. A tank large enough to store water for just one month of operation (100 gallons) would be larger than the entire fuel cell system. In order for water to be delivered to the system by pipeline, additional cost and complexity are encountered.

On the other hand, the three moles of hydrogen produced on the right-hand-side of Eq. (1) ultimately combines with oxygen from the air at the fuel cell anode to make three moles of steam—more than enough to sustain continuous reforming. Some fuel cell designers envision blending a portion of the anode exhaust gas stream back into the incoming fuel stream. But recirculating and controlling the flow of only a portion of a very hot gas stream is not a trivial undertaking. An alternative design approach is to cool the exhaust stream below the boiling point and condense out the water. This approach requires reheating the water to make steam and then re-injecting it into the incoming fuel stream.

Mixed Ion Conducting Ceramic Materials and Water Vapor Permeation

Certain oxide ceramic materials with intrinsic and extrinsic oxygen ion vacancies, are known to take up and release water vapor. The best known and most extensively studied examples are yttrium-doped barium cerate, BaCe_{0.9}Y_{0.1}O₃₋₆ (BCY10) and yttrium-doped barium zirconate BaZr_{0.9}Y_{0.1}O₃₋₆ (BZY10). Solid state hydration occurs by the Wagner reaction:
H₂O(g)+V₀^{••}+O₀^{x}⇄2 OH₀^{•} (2)

A water molecule enters an oxygen vacancy at the surface, donating two protons to the lattice. The quasi-free protons reside near oxygen ions, hoping from lattice site to lattice site by the Grotthus mechanism. The oxygen ion sublattice remains stationary. This reaction occurs at any free surface of the ceramic exposed to water vapor, and has an equilibrium constant:

$${K}_{H} = \frac{{[ O {H}_{O}^{.} ]}^{2}}{{p}_{{H}_{2} O} [ {V}_{O}^{..} ]} \qquad ( 3 )$$

The Wagner reaction, Eq. 2, is reversible, so either hydration or dehydration may occur depending on the local partial pressure of water vapor and the value of the equilibrium constant. When the pressure of water vapor is low, the ceramic dehydrates, generating oxygen vacancies by the reverse of Eq. 2. Electron transfer does not take place with this reaction, so no electrodes are required. In some instances, the reaction kinetics may be improved by the application of a metal coating, such as porous platinum, on the ceramic. Whenever a partial pressure gradient of water vapor exists across the mixed ion conducting ceramic membrane, oxygen ion vacancies and protons are free to migrate in opposite directions by ambipolar diffusion. This is possible since both species are positively charged. The chemical diffusion of water by this mechanism may be derived as:

$${\tilde{D}}_{{H}_{2} O} = \frac{( 2 - X ) {D}_{O {H}_{O}^{.}} {D}_{{V}_{O}^{..}}}{X {D}_{O {H}_{O}^{.}} + 2 ( 1 - X ) {D}_{{V}_{O}^{..}}} \qquad ( 4 )$$

where D_{OH}_{₀}_{^{•}} and D_{V}_{₀}_{^{••}} are the self-diffusivities of oxygen ion vacancies and protonic defects, and X is the degree of hydration, defined as the site fraction of oxygen ion vacancies filled by water molecules. There are two protonic defects, OH₀^{•}, created for each water molecule that hydrates the lattice. The oxygen vacancy concentration in the dehydration limit, as X→0 is largely determined by the extrinsic dopant concentration in the as-fired ceramic, (i.e., [Y′_{Ce}] in BCY10 and [Y′_{Zr}] in BZY10). The hydration (or saturation) limit, [OH₀^{•}]^{o}, as X→1, occurs when all of the oxygen vacancies have been “stuffed” with water molecules, and their concentration approaches zero.

Although molecular “steam” does not diffuse through the electrolyte membrane per se—this is an entirely solid-state process—steam is, nonetheless, transported across the membrane from the moist atmosphere on one side of the membrane (where hydration occurs) to the dryer atmosphere on the other (where dehydration occurs). For BCY10 and BZY10, a critical temperature range exists between about 600° C. and 1000° C., where the degree of hydration goes from the saturation limit (X→1) at low temperatures, to complete dehydration at high temperatures (X→0). The ambipolar diffusivity of steam falls between D_{V}_{₀}_{^{••}} in the fully hydrated ceramic (X=1) and D_{OH}_{₀}_{^{•}}; when the material is completely dehydrated (X=0). The protonic carrier concentration of the ceramic electrolyte is determined by the local degree of hydration. Water vapor is formed and oxygen ion vacancies are created by the reverse of Eq. 2 at the surface where pH₂O is low. This ensures that the concentration profile of protonic defects and oxygen ion vacancies across the ceramic membrane is determined dynamically by the steam partial pressures on either side of the membrane. Steam permeation will occur whenever there is a steam pressure gradient across the membrane.

Whenever hydrocarbon molecules, carbon monoxide, or even solid carbon are present on one side a steam permeable membrane, water vapor at the surface of the ceramic is rapidly consumed in reforming and shift reactions, resulting in a low pH₂O. When a higher water vapor partial pressure exists on the other side of the membrane, steam permeates through the membrane, driven by the steam pressure gradient. The steam partial pressure in SOFC exhaust is typically between 0.4 to 0.6. This provides a large driving force for steam permeation to the relatively dry conditions that pertain in the incoming fuel.

Steam permeation provides an efficient mechanism for reforming hydrocarbon fuels directly. Furthermore, the effect is self-regulating. Once the fuel and/or carbon monoxide begin to be depleted by reacting with available water vapor, the water vapor partial pressure in the fuel channel will rise, the concentration gradient across the membrane will decrease, and the steam permeation flux will diminish accordingly. This is a localized effect that occurs along the length of the channel so that as fuel is reformed while it flows down the channel, the flux of water vapor is proportionately reduced.

Bulk Hydration Considerations

Equation 4 shows that the chemical diffusion of water depends strongly on the degree of hydration, X. The degree of hydration may only be known precisely at the surfaces in equilibrium with the gas phase. The concentration profile of protonic defects across the ceramic membrane may not be known, but it is possible to model the steady state steam permeation flux by integrating the flux equation with \tilde{D}_{H}_{₂}_{O} and applying suitable boundary conditions at the two respective gas/electrolyte interfaces. The self-diffusivities of oxygen ion vacancies and protonic defects are not independent of X, but reasonable average values obtained may be used. [OH₀^{•}] and [V₀^{••}] in Eq. (2) are not independent. Stoichiometry requires that two protonic defects are produced for each oxygen vacancy annihilated, while only one water molecule enters the lattice for each oxygen vacancy annihilated,
2Δ└OH₀^{•}┘=−Δ└V₀^{••}┘=Δ[H₂O]_{bulk} (5)

Using Eq. (5) with site and charge balance constraints, the protonic defect concentration can be determined by:

$$[ O {H}_{O}^{.} ] = \frac{3 {K}^{′} - \sqrt{{K}^{′} ( 9 {K}^{′} - 6 {K}^{′} S + {K}^{′} {S}^{2} + 24 S + 4 {S}^{2}}}{{K}^{′} - 4} \qquad ( 6 )$$

where K′=K_{H}p_{H}_{₂}_{O} and S=└OH_{O}^{•}┘^{o}, the concentration of protonic defects in the saturation limit (which is twice the concentration of oxygen vacancies in the dehydration limit). Assuming all the oxygen vacancies in the dehydration limit are due to the extrinsic dopant concentration, then S≈[Y′_{Ce}], the extrinsic yttrium dopant concentration (about 1.95×10⁻³ mol/cm³ in BCY10). In Eq. (4), X is defined as the fraction of oxygen vacancies “stuffed” with water molecules:

$$X ≡ \frac{{[ {H}_{2} O ]}_{bulk}}{S} \approx \frac{{[ {H}_{2} O ]}_{bulk}}{[ {Y}_{Ce}^{′} ]} \qquad ( 7 )$$

Steam Permeation Flux Model

Fick's first law for steady-state diffusion through the membrane gives the effective steam permeation flux:

$${J}_{ss} = - D ( C ) \frac{\partial C}{\partial x} \qquad ( 8 )$$

a non-linear differential equation, which may be integrated as long as D depends only on concentration. The concentration, C, is equivalent to the bulk water concentration, [H₂O]_{bulk}. It is related to X by Eq. (7). The flux integral may be written as:

$${J}_{{H}_{2} O} = - \frac{1}{Δ x} {\int }_{{C}_{I}}^{{C}_{II}} {\tilde{D}}_{{H}_{2} O} ( C ) ⅆ C \qquad ( 9 )$$

Δx is the electrolyte membrane thickness, and the subscripts, I and II, refer to the moist and dry surfaces, respectively. Substituting in Eq. (4) with variable substitution gives:

$${J}_{{H}_{2} O} = - \frac{{D}_{O {H}_{O}^{.}} {D}_{{V}_{O}^{..}}}{Δ x} {\int }_{{C}_{I O}}^{{C}_{II}} \frac{( γ - C ) ⅆ C}{a C + b} \qquad ( 10 )$$

where: γ=2[Y′_{Ce}];

a=(D_{OH}_{₀}_{^{•}}−2D_{V}_{₀}_{^{••}}); and

b=2D V_{V}_{₀}_{^{••}}
Eq. (10) may be integrated in closed form to give:

$${J}_{{H}_{2} O} = \frac{{D}_{O {H}_{O}^{.}} {D}_{{V}_{O}^{..}}}{Δ x ( {D}_{O {H}_{O}^{.}} - 2 {D}_{{V}_{O}^{..}} )} [ ( {C}_{II} - {C}_{I} ) + ( \frac{b}{a} + γ ) ln [ \frac{( a {C}_{I} + b )}{( a {C}_{II} + b )} ] ] \qquad ( 11 )$$

Hydration Isobars and Boundary Conditions

The equilibrium hydration constant, K_{H}, which determines C_{I} and C_{II}, depends on temperature. The enthalpy and entropy of hydration are related to K_{H} by:

$$ln ( {K}_{H} ) = - \frac{Δ H °}{{k}_{B} T} + \frac{Δ S °}{{k}_{B}} \qquad ( 12 )$$

and have been determined for several protonic ceramic materials by fitting Eq. (6) to a curve of specimen weight versus temperature at constant pH₂O. An alternative technique for determining degree of hydration, using dilatometry to measure lattice expansion, may also be used. Enthalpy and entropy data for BCY10 and BZY10 are given in Table 1.

TABLE 1
Hydration Enthalphy and Entropy for Various Protonic Materials
at a Constant Water Vapor Pressure of 0.025 atm

| | ΔH° | ΔS° | └OH _{O}^{•}┘/ | |
|---|---|---|---|---|
| Material | kJ/mol) | (J/mol · K) | [Y_{B}^{′}] | Investigator |
| BCY10 | −162.2 | −166.7 | 0.85 | Kreuer |
| BCY10 | −156.1 | −145.2 | 0.95 | Coors et al |
| BZY10 | −75.73 | −86.24 | 0.80 | Kreuer |

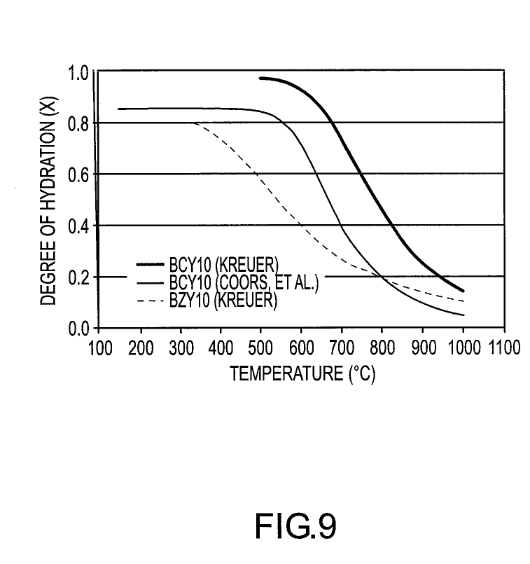

The fourth column reflects the degree of hydration in the hydration limit (at low temperature) with respect to the extrinsic dopant concentration. Kreuer found that it was not possible to fill all of the vacancies upon decreasing temperature. But in our dilatometry measurements, we found that the amount of “frozen in” hydration at room temperature was actually about 25% lower than what was observed at 600° C. by dilatometry. We presumed that this was due to a lower solubility of water in the low temperature phases. The degree of hydration versus temperature, using Eq. (6), and the thermodynamic values from Table 1, at a constant water vapor pressure of 0.025 atm, is shown in FIG. 9.

The dotted line below 500° C. reflects that the Kreuer model, which predicts constant hydration at decressing temperatures once the terminal hydration is reached, does not fit our dilatometry data. It may be observed that the temperatures at which the equilibrium constants, K_{H}, are equal to unity for BZY10, BCY10 (Kreuer) and BCY10 (Coors, et al.); are 600, 700 and 800° C., respectively. This is the inflection point of the curves, where hydration and dehydration occur at equal rates, and is the characteristic dehydration temperature, T_{c}. Qualitatively, in order to maximize temperature at which steam permeation is greatest, it is desirable to maximize T_{c}. The discrepancy between Kreuer's curve and ours is not simply due to a translation in the vertical direction, since both curves are asymptotic to the horizontal axis at large T. The uncertainty in these empirical data underscores the need for gaining a better understanding of the thermodynamics of Wagner hydration and dehydration.

Steam Permeation Flux

Self-diffusivities of oxygen ion vacancies and protonic defects were measured by Kreuer on single crystal BCY10. We obtained quite different values on polycrystalline BCY10 by partial conductivity measurements in dry and moist helium. The values are shown in Table 2.

TABLE 2
Self Diffusivities for Oxygen Ion Vacancies and Protonic Defects in BCY10

| | D_{V}_{_{O}}_{••} | | D_{OH}_{_{O}}_{•} | | |
|---|---|---|---|---|---|
| | pre-exp. | D_{V}_{_{O}}_{••} | pre-exp. | D_{OH}_{_{O}}_{•} | |
| Material | [cm²/s] | Eₐ [eV] | [cm²/s] | Eₐ [eV] | Investigator |
| BCY10 single | 1.10 × 10 − 2 | 0.71 | 2.00 × 10 − 2 | 0.54 | Kreuer |
| crystal | | | | | |
| BCY10 ceramic | 3.63 × 10 − 3 | 0.55 | 7.74 × 10 − 4 | 0.35 | Coors et al. |

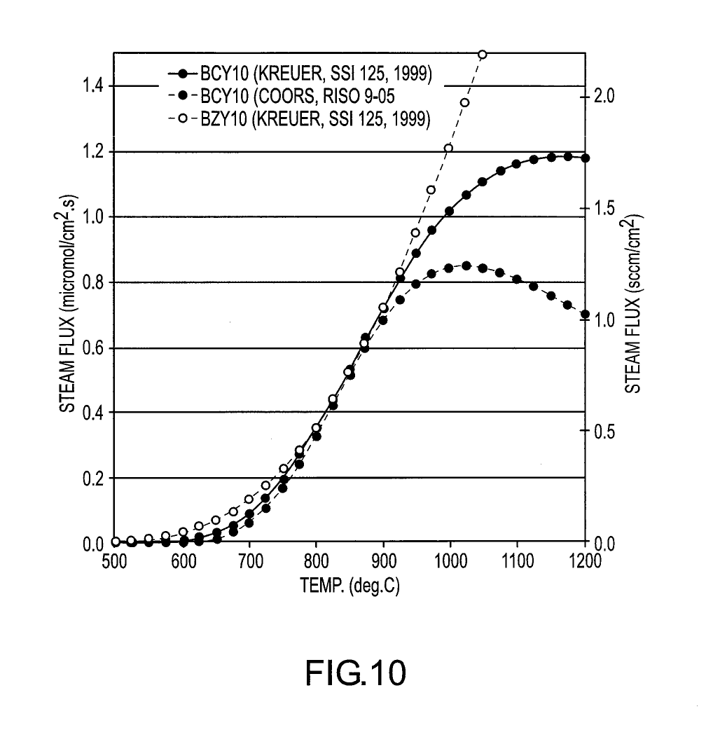

A plot of the steam permeation flux versus temperature based on Eq. 11 is shown in FIG. 10. Kreuer's diffusivity values from Table 2 for BCY10 were also used for BZY10. The data is plotted for a 500 micron thick membrane with 0.5 atm of steam on the moist side and 0.01 atm on the dry side. The units on the left-hand side are μmoles/cm²·sec, and equivalent units of standard cubic centimeters per minute (sccm)/cm² of membrane surface are shown on the right-hand side.

Several interesting observations may be made. First, the predicted steam flux is quite substantial above 700° C., even for this relatively thick membrane. In each case, the steam flux increases from some small value, due to the exponential increase in the ionic self-diffusivities, to a maximum, beyond which, the bulk concentration of water decreases due to dehydration. This peak for BCY10 occurs at 1175° C., using Kreuer hydration parameters, and at 1025° C. using our parameters. For BZY10, the peak occurs at 1350° C. (which is off the plot.) Second, the quantitative difference in predicted steam flux in BCY10, using Kreuer's parameters and ours, is small below about 900° C. This is rather surprising, given the wide discrepancy of measured parameters. Finally, the difference in steam flux between BCY10 and BZY10 below 900° C. is also slight. The three plots only diverge significantly above 900° C., where the different dehydration temperatures become important. Protonic materials with greater self diffusivities may be developed in order to obtain still higher steam fluxes.

At 850° C., a steam flux of 0.53 μmol/cm² sec is predicted from FIG. 10. For a 25 micron thick membrane under the same conditions, the flux would be 20 times greater, or 10.6 μmol/cm²·sec. This corresponds to about 15 sccm/cm². For a steam to carbon ratio of 1:1, 1 cm² of steam-permeable membrane should provide enough steam to reform 15 sccm of methane. Since a 5 kW SOFC requires about 25 moles of methane per hour (about 611 standard liter/hr or 10,200 sccm), about 680 cm² of membrane area would be needed—less than 10 meters of 1 cm diameter BCY10 or BZY10-coated, porous tubing.

Protonic ceramic membranes have been shown to work as electrochemical devices such as hydrogen sensors, protonic ceramic fuel cells (PCFCs), galvanic hydrogen separators, and combined hydrogen and power (CH₂P) devices, among other types of devices. In most of these applications, the oxygen partial pressure is high on at least one side of the membrane. In high oxygen pressure, these materials typically have a large hole defect contribution at elevated temperature, with a concomitant reduction in oxygen ion vacancies. The ambipolar steam permeation model described in this report treats only oxygen ion vacancies and protons as significant charge carriers.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the ceramic” includes reference to one or more ceramics and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. An apparatus for separating water vapor from a water-vapor containing gas mixture, the apparatus comprising:
a mixed ion conducting membrane having at least a portion of one surface exposed to the water-vapor containing gas mixture and at least a portion of a second surface, that is opposite the first surface, that is exposed to a second gas mixture with a lower partial pressure of water vapor,
wherein the membrane comprises at least one non-porous, gas-impermeable, solid material that can simultaneously conduct oxygen ions and protons, and wherein at least some of the water vapor from the water-vapor containing gas mixture is selectively transported through the membrane to the second gas mixture.

2. The apparatus of claim 1, wherein the transport of the water vapor through the membrane does not require an external electric current to be supplied to the membrane.

3. The apparatus of claim 1, wherein the membrane has an ionic conductivity of about 90% to about 99% or more of the total conductivity of the membrane.

4. The apparatus of claim 1, wherein heat is also transported across the membrane from the water-vapor containing gas mixture to the second gas mixture.

5. The apparatus of claim 1, wherein heat is also transported from the second gas mixture to the water-vapor containing gas mixture.

6. The apparatus of claim 1, wherein the membrane forms an inner conduit that is surrounded by an outer conduit, wherein at least a portion of the water-vapor containing gas mixture is in a first region within the inner conduit, and at least a portion of the water vapor from the water-vapor containing gas mixture is transported through the membrane to a second region between the inner conduit and the outer conduit.

7. The apparatus of claim 6, wherein at least a portion of the second region between the inner conduit and outer conduit comprises a porous material.

8. The apparatus of claim 7, wherein the porous material provides structural support for the mixed ion conducting membrane.

9. The apparatus of claim 7, wherein the porous material comprises a material for catalyzing a reaction between the transported water vapor and one or more reactants in the second gas mixture.

10. The apparatus of claim 7, wherein the mixed ion conducting membrane comprises a coating on a surface of the porous material.

11. The apparatus of claim 10, wherein the mixed ion conducting membrane has a thickness of about 0.1 mm or less.

12. The apparatus of claim 1, wherein the membrane forms an inner conduit that is surrounded by an outer conduit, wherein at least a portion of the water-vapor containing gas mixture is in a first region between the inner conduit and the outer conduit, and at least a portion of the water vapor from the water-vapor containing gas mixture is transported through the membrane to a second region within the inner conduit.

13. The apparatus of claim 12, wherein at least a portion of the second region between the inner conduit and outer conduit comprises a porous material.

14. The apparatus of claim 1, wherein water vapor enters and exits the mixed ion conducting membrane by the Wagner mechanism, where the oxygen atoms from first water molecules at the first surface enter oxygen ion vacancies and the hydrogen atoms from the water molecules simultaneously enter interstitial sites at the first surface, and hydrogen and oxygen atoms, in the ratio of two to one, exit from the second surface, creating oxygen ion vacancies at the second surface and second water molecules.

15. The apparatus of claim 1, wherein the mixed ion conducting membrane transports water vapor by a migration of protons and oxygen ion vacancies in opposite directions through the membrane.

16. The apparatus of claim 1, wherein the membrane comprises a perovskite ceramic having a general formula:
ABO₃,
wherein A is selected from the group consisting of calcium, strontium, barium, lanthanum, a lanthanide series metal, an actinide series metal, and a mixture thereof, and B is selected from a group consisting of zirconium, cerium, yttrium, titanium, transition metals and mixtures thereof.

17. The apparatus of claim 1, wherein the mixed ion conducting ceramic material comprises BaZr₁₋ₓYₓO₃₋₆, where x is less than 0.5, and δ is 0 to x/2.

18. The apparatus of claim 6, wherein the inner and outer conduits have tubular cross sections.

19. The apparatus of claim 1, wherein the apparatus comprises a plurality of mixed ion conducting membranes that form a catalytic membrane reactor.

20. A method of separating water vapor from a water-vapor containing gas mixture, the method comprising:
providing a mixed ion conducting membrane comprising at least one non-porous, gas-impermeable, solid material that can simultaneously conduct oxygen ions and protons; and
exposing a first surface of the membrane to the water-vapor containing gas mixture and a second, opposite surface of the membrane to a second gas mixture with a lower partial pressure of water vapor,
wherein at least some of the water vapor from the water-vapor containing gas mixture is selectively transported through the membrane to the second gas mixture.

21. The method of claim 20, wherein the transport of the water vapor through the membrane does not require an external electric current to be supplied to the membrane.

22. The method of claim 20, wherein the membrane has an ionic conductivity of about 90% to about 99% or more of the total conductivity of the membrane.

23. The method of claim 20, wherein heat is also transported across the membrane from the water-vapor containing gas mixture to the second gas mixture, or transported from the second gas mixture to the water-vapor containing gas mixture.

24. The method of claim 20, wherein the membrane comprises a perovskite ceramic having a general formula:
ABO₃,
wherein A is selected from the group consisting of calcium, strontium, barium, lanthanum, a lanthanide series metal, an actinide series metal, and a mixture thereof, and B is selected from a group consisting of zirconium, cerium, yttrium, titanium, transition metals and mixtures thereof.

25. The method of claim 20, wherein the mixed ion conducting ceramic material comprises BaZr₁₋ₓYₓO₃₋₆, where x is less than 0.5, and δ is 0 to x/2.

26. A method of concentrating carbon dioxide in a carbon dioxide and water vapor containing gas mixture, the method comprising:
providing a mixed ion conducting membrane comprising at least one non-porous, gas-impermeable, solid material that can simultaneously conduct oxygen ions and protons and is impermeable to carbon dioxide;
exposing a first surface of the membrane to the carbon dioxide and water-vapor containing gas mixture and a second, opposite surface of the membrane to a second gas mixture having a lower partial pressure of water vapor;
concentrating the carbon dioxide in the carbon dioxide and water vapor containing gas mixture by selectively transporting at least some of the water vapor to the second gas mixture.

27. The method of claim 26, wherein the method further comprises transporting the concentrated carbon dioxide and water vapor containing gas mixture to a storage site.

28. The method of claim 27, wherein the storage site comprises an underground formation or a storage container.

29. The method of claim 26, wherein the carbon dioxide and water vapor containing gas mixture is generated from the combustion of hydrocarbons with oxygen.
